(19) United States
(12) Patent Application Publication
(10) Pub. No.: US 2026/0217446 A1
(43) Pub. Date: Jul. 30, 2026

(54) REFILL LEAD CASE

(71) Applicant: MITSUBISHI PENCIL COMPANY, LIMITED, Tokyo (JP)

(72) Inventors: Shigeki OOBA, Fujioka-shi (JP); Mitsuhiro KAWABATA, Fujioka-shi (JP); Shigeyoshi SATO, Tokyo (JP)

(73) Assignee: MITSUBISHI PENCIL COMPANY, LIMITED, Tokyo (JP)

(21) Appl. No.: 19/143,485

(22) PCT Filed: Dec. 22, 2023
(86) PCT No.: PCT/JP2023/046229

§ 371 Date: Jun. 26, 2025

(30) Foreign Application Priority Data
Jan. 11, 2023 (JP) 2023-002555

(51) Int. Cl. B65D 85/24; A45C 11/36

(52) U.S. Cl. CPC B65D 85/24; A45C 11/36

(57) ABSTRACT

Provided is a refill lead case that includes a case body 1 having a lid 2 that is openably attached to a refill lead removal opening 1b formed at one end in the longitudinal direction of a refill lead accommodating space 1a formed in the shape of a long article by being surrounded by a back plate 1c and right and left leg plates 1d and a cover member 5 which has a front face plate 5a covering the refill lead accommodating space with a predetermined distance from the back plate of the case body and which is slidably movable against the case body along the longitudinal direction of the refill lead accommodating space. Clicking protrusions 51d are formed on the inner surface of the cover member facing the case body to cause a clicking action between the case body and the cover member by the sliding operation.

### TECHNICAL FIELD

The present invention relates to a refill lead case that accommodates refill leads to be used, for example, in a mechanical pencil.

### BACKGROUND ART

A refill lead case that accommodates refill leads to be used in such as a mechanical pencil is often composed of two parts, a case body having a bottom formed in a longitudinal shape and a lid that is detachably attached to an opening of the case body.

The refill lead case disclosed in Patent Literature 1, for example, is composed of two parts, a case body made of resin material and a lid made of a resin material; the opening of the case body, a refill lead removal opening, is opened by sliding the lid in the direction perpendicular to the longitudinal direction of the refill lead case.

In this case, the sliding position of the lid against the opening of the case body is configured to be adjustable in two steps, allowing the user to set the opening to the appropriate width for removing a refill lead.

The refill lead case disclosed in Patent Literature 2 is composed of two parts, a case body similarly made of resin material and a lid made of a resin material; a lid is detachably attached to the opening of the case body having a bottom.

The opening formed in the case body, a refill lead removal opening, is cut away obliquely on the front face side; the case body is configured to allow the user to pinch the refill lead with their fingers, resulting in an easy-to-use refill lead case.

However, in the refill lead cases disclosed in Patent Literature 1 and 2, for both cases, an operation is required to tilt the case body slightly downward with the lead removal opening open. The required refill lead is removed using the action of the lead coming out of the case body toward the lead removal opening due to its own weight.

The above method requires a subtle operation of swinging the case body while adjusting the inclination of the case body. If incorrectly operated, more refill leads than necessary, or all of the leads in the case body would come out of the refill lead removal opening and scatter on the floor; in this case, there may be a situation where the scattered refill leads should be picked up.

In order to overcome the problem of the refill lead case, the present applicant has previously proposed a refill lead case with which the required refill leads can be easily removed without the refill lead removal opening being directed downward, which is disclosed in Patent Literature 3.

According to the refill lead case disclosed in Patent Literature 3, against the case body of the back side formed in a longitudinal shape, by pulling the cover member formed in a longitudinal shape of the front face side toward the user and by sliding to advance the case body of the rear side relatively forward, the lid formed integrally with the tip portion of the case body operates so as to warp and turn toward the rear side, thereby opening the refill lead removal opening in a state where the tip end of the refill leads accommodated in the case is projected from the wide refill lead removal opening.

Thus, since the necessary refill lead can be easily removed by pinching with fingers without the refill lead removal opening directed downward, the refill lead case can be provided that overcomes the problem of many refill leads coming out at the same time, which the conventional refill lead case holds.

### CITATION LIST

### Patent Literature

PTL 1: JP-A-2010-030136
PTL 2: JP-A-2010-173248
PTL 3: JP-A-2022-096637

### SUMMARY OF INVENTION

### Technical Problem

According to the refill lead case disclosed in PTL 3, a click mechanism is provided between the relatively slidable case body and the cover member. In a storage state of the refill lead case accommodating refill leads, the state in which the lid is reliably closed can be maintained with consideration.

In the refill lead case disclosed in Patent Document 3, leg plates are formed on each of the case body and the cover member, both of which are formed in a flat shape, in the thickness direction on the right and left thereof. Since a rib-shaped projection is formed on the leg plate to form a click mechanism, there is a limit to the width of the rib-shaped protrusion to be formed.

Therefore, in the sliding operation between the case body and the cover member, it is difficult to obtain an operating feeling with a distinct clicking sensation. In addition, when the case body and the cover member are made of a resin material, since the width of the formation of rib-like protrusions is narrow, the abrasion of the rib-like protrusions tends to progress. As a result, it is difficult to maintain the clicking mechanism over a long period of time, which may cause the value of the product to deteriorate.

This invention was made by focusing on the problem of the conventional refill lead case and the objective thereof is to provide a refill lead case in which an operating feeling with a distinct clicking sensation is obtainable in the sliding operation between the case body and the cover member, and a proper clicking function can be maintained over a long period of time.

### Solution to Problem

A refill lead case according to the present invention includes a case body having a refill lead accommodating space which is defined as an inner space formed in the shape of a long article by being surrounded by a back plate and right and left leg plates, the case body being provided with a lid that is openably attached to a refill lead removal opening formed at one end of the refill lead accommodating space in the longitudinal direction; and a cover member having a front plate that covers the refill lead accommodating space with a predetermined distance from the back plate of the case body and is slidably movable against the case body along the longitudinal direction of the accommodating space, wherein on the inner surface facing the case body of the front plate of the cover member, clicking protrusions are formed to cause a clicking action between the front plate and the case body by the sliding operation, and the lid covering the refill lead removal opening is opened accompanying the sliding operation of retracting the cover member toward the other end relative to the case body.

In this case, a wall member is disposed in the case body to cover the refill lead accommodating space of the case body, and a plate spring is also disposed by being fixed to the case body between the wall member and the cover member. On the surface of the plate spring facing the cover member, a spring side protrusion is desirably formed, by which a clicking operation is performed by climbing over the clicking protrusions formed on the cover member by the sliding operation.

In addition, each of the case body, the lid, the cover member, the wall member, and the plate spring is made of a metallic material.

In addition, in a preferred embodiment, the clicking protrusion formed on the cover member has a predetermined length along the direction of sliding against the case body. It is configured such that the spring side protrusion climbs over the clicking protrusions by sliding operation, in a first state where the cover member is most advanced against the case body and the lid is closed and in a second state where the cover member is most retracted backward and the cover member is open.

### Advantageous Effects

In the refill lead case according to the present invention, on the cover member with which a sliding operation is performed between the cover member and the case body, a clicking protrusion that causes a clicking operation to be performed between the case body is formed on the inner surface facing the case body on the front face plate of the cover member.

Since the refill lead case is generally formed in a flat, thin, and long rectangular shape for accommodating refill leads, as in an embodiment described later, the clicking protrusion can be made to have a larger width for performing the clicking operation by forming the clicking protrusion on the inner surface of the front surface of the cover member.

Accordingly, the relative sliding operation between the case body and the cover member allows the user to have an operating feeling accompanied by a distinct clicking sensation, and a refill lead case can be provided which inhibits an abrasion of the clicking protrusion over a long period of time and can maintain a proper clicking function.

### BRIEF DESCRIPTION OF DRAWINGS

FIG. 1 is a perspective view illustrating each of the components that make up a refill lead case in an unfolded state;

FIG. 2 is a perspective view of the refill lead case with a lid closed;

FIG. 3 is a perspective view of the refill lead case with the lid open;

FIG. 4 is a plan view according to the present invention;

FIG. 5 is a front view of the refill lead Case;

FIG. 6 is a bottom view of the refill lead Case;

FIG. 7 is a rear view of the refill lead case;

FIG. 8 is a cross-sectional view of the refill lead case seen in the direction of the arrow from line a-a in FIG. 4;

FIG. 9 is a partially enlarged view of FIG. 8;

FIG. 10 is a plan view of the refill lead case with the lid open;

FIG. 11 is a front view of the refill lead case;

FIG. 12 is a cross-sectional view of the refill lead case in FIG. 10 seen in the direction of the arrow from line b-b;

FIG. 13 is a partially enlarged view of FIG. 12;

FIG. 14A shows a single-article configuration of the case body; (A) is a plan view, (B) is a front view, (C) is a cross-sectional view thereof as seen in the direction of the arrow from line c-c in (A), and (D) is a bottom view;

FIG. 14B shows a single-article configuration of the case body; (A) is a perspective view seen from the inside, (B) is a left side view, (C) is a right side view.

FIG. 15 shows a single-article configuration of the lid; (A) is a plan view, (B) is a front view, (C) is a cross-sectional view thereof as seen in the direction of the arrow from line d-d in (A), (D) is a bottom view, (E) is a perspective view seen from the rear side, and FIG. (F) is a perspective view seen from the inside;

FIG. 16A FIG. 16 shows a single-article configuration of the wall member; (A) is a plan view, (B) is a front view, (C) is a cross-sectional view thereof seen in the direction of the arrow from line e-e in (A), and (D) is a bottom view;

FIG. 16B shows a single-article configuration of the wall member; (A) is a perspective view seen from the inside, (B) is a left side view, and (C) is a right side view;

FIG. 17A shows a single-article configuration of the plate spring; (A) is a plan view, (B) is a front view, (C) is a cross-sectional view thereof seen in the direction of the arrow from line f-f in (A), and (D) is a bottom view;

FIG. 17B shows a single-article configuration of the plate spring; (A) is a perspective view seen from the front side, (B) is a left side view, and (C) is a right side view;

FIG. 18A shows a single-article configuration of the cover member; (A) is a plan view, (B) is a front view, and (C) is a cross-sectional view seen from line g-g in (A), and (D) is a bottom view; and

FIG. 18B shows a single-article configuration of the cover member; (A) is a perspective view seen from the inside, (B) is a left side view, and (C) is a right side view.

### DESCRIPTION OF EMBODIMENTS

The refill lead case according to the present invention will be described with reference to the drawings.

In the respective drawings below, the same reference signs are given for the same part, but in some of them due to the page limitation, reference signs are given for the representative parts, and the details thereof will be described with reference to the reference signs given in the drawing showing a single-article configuration.

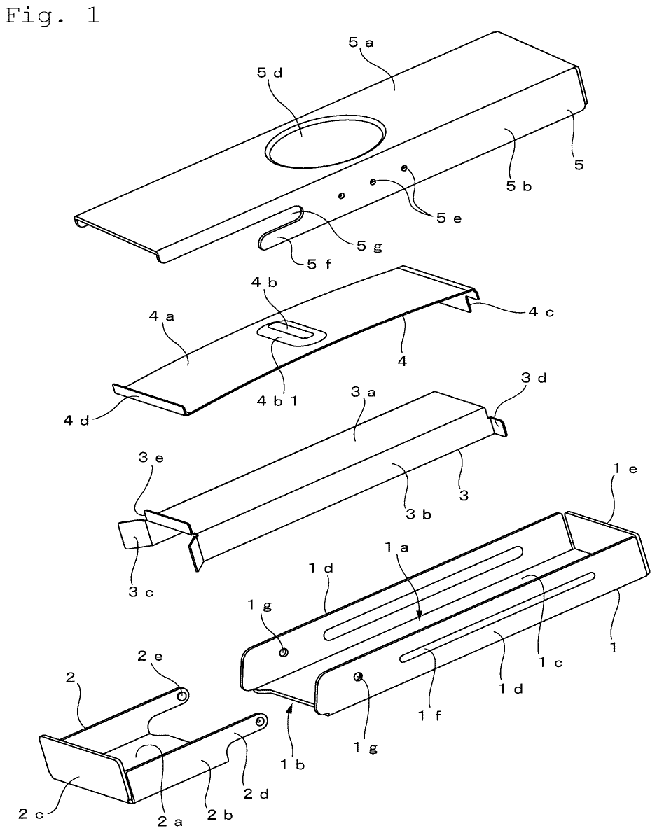

FIG. 1 is a perspective view illustrating each of the components constituting a refill lead case in an unfolded state; the refill lead case is composed of a case body 1, a lid 2, a wall member 3, a plate spring 4, and a cover member 5, and these parts are preferably press-formed from a metal material such as stainless steel.

In the case body 1, an inner space is formed in a longitudinal shape, and the longitudinal inner space constitutes a refill lead accommodating space 1a. One end of the refill lead accommodating space in the longitudinal direction forms a refill lead removal opening 1b, and a lid 2, which allows the refill lead removal opening 1b to be openable, is rotatably mounted on the case body 1.

A wall member 3 is disposed in the case body 1 so as to cover the refill lead accommodating space 1a of the case body 1, and the plate spring 4 is attached and disposed on the case body 1.

In the state in which the wall 3 and the plate spring 4 are stored in the case body 1, the cover member 5 is slidably attached to the case body 1 thereover.

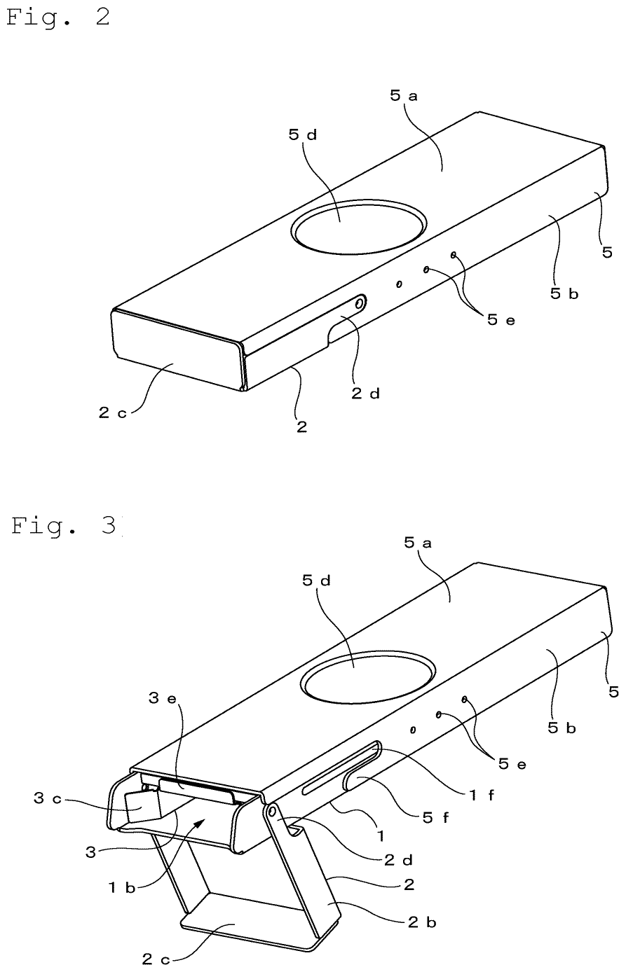

FIGS. 2 and 3 are perspective views showing an appearance configuration of the refill lead case which is assembled with each of the components. FIG. 2 shows a first state in which, by the sliding operation of the cover member 5 against the case body 1, the cover member 5 is most advanced against the case body 1 and the lid 2 is closed. FIG. 3 shows a second state in which, by the above sliding operation, the cover member 5 is most retracted against the case body 1 and the lid 2 is open.

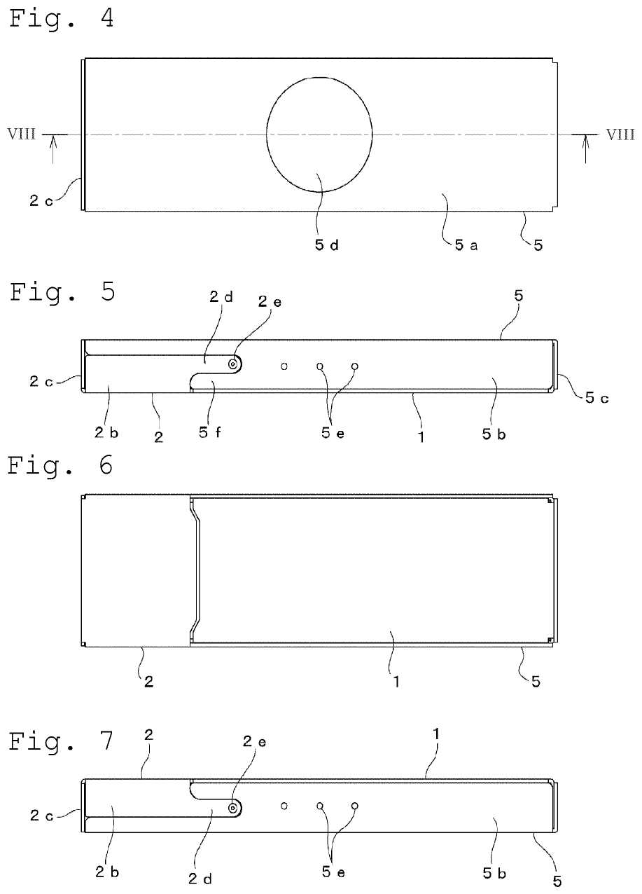

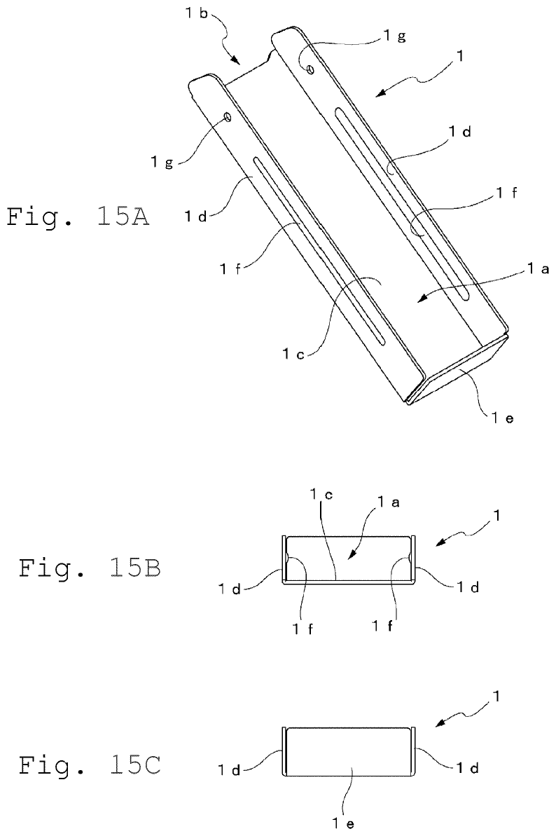

FIGS. 4 to 9 show the refill lead case in the first state by some parts of the orthographic projection drawings and the cross-sectional views, and FIGS. 10 to 13 show the refill lead case in the second state by some parts of the orthographic projection drawings and the cross-sectional views.

It should be noted that for the convenience of the description below the side of the lid 2 attached to the case body 1, i.e., the side of the refill lead removal opening 1b will be referred to as one end or front end of the refill lead case and the opposite side will be referred to as the other end or rear end.

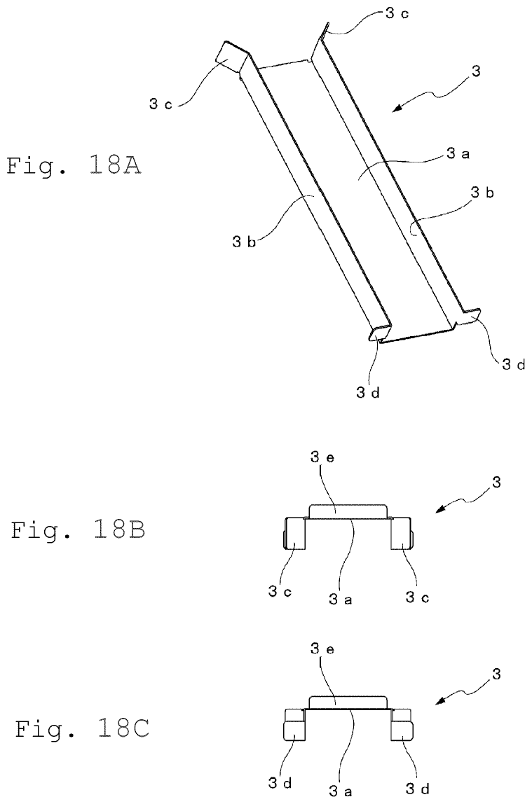

Each single-article configuration of the case body 1, the lid 2, the wall member 3, the plate spring 4, and the cover member 5 is shown in FIG. 14 to FIG. 18; the configuration of each component will be described with reference to each drawing showing the single-article configuration.

The case body 1 shown in FIG. 14A and FIG. 14B is formed in a U-shape having a cross section perpendicular to the longitudinal direction by a rectangular back plate 1c and right and left leg plates, and the inside surrounded in three directions by right and left leg plates 1d and rear end blocking plate 1e closing the rear end forms the refill lead accommodating space la with the back plate 1c as the bottom. In addition, the front end side thereof is open to form the refill lead removal opening 1b.

Linear recesses 1f, recessed from the outside to the inside, are formed in the right and left leg plates 1d by press machining in parallel along the longitudinal direction, respectively. The linear recesses 1f serve to support the cover member 5, which will be described later, slidably in the longitudinal direction.

In addition, shaft holes 1g are formed on the front end side of the right and left leg plates 1d, respectively, facing each other; the pair of shaft holes 1g is to be used for rotatably mounting the lid 2, which will be described later, at the refill lead removal opening 1b.

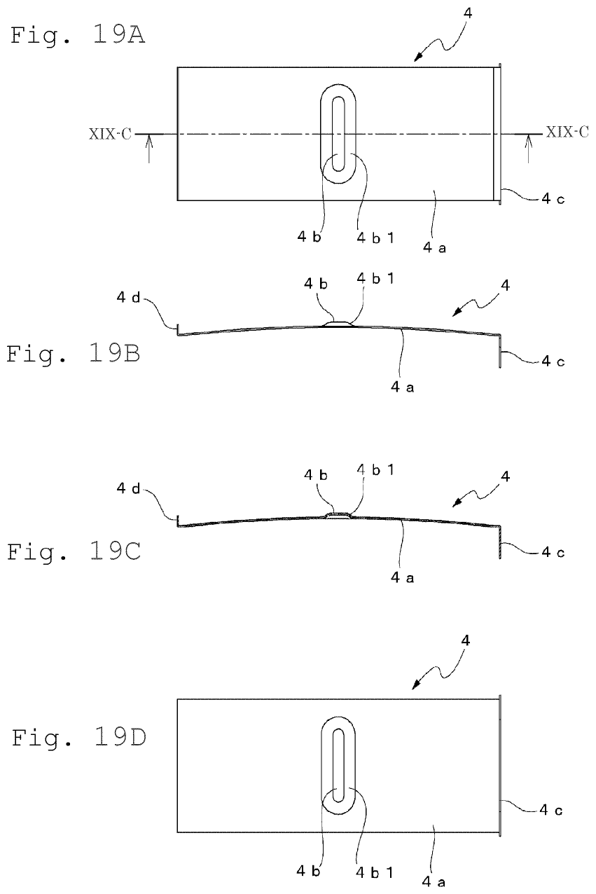

The lid 2 shown in FIG. 15 is provided with leg plates 2b formed on the right and left of the back plate 2a by bending and the front end blocking plate 2c formed on the front end of the back plate 2a by bending in the same direction as the leg plate 2b; the space surrounded by the pair of the leg plates 2b and the front end blocking plate 2c constitutes the inside of the lid 2.

In addition, a pair of long thin legs 2d extending toward the rear end and having approximately the same length is continuously formed from the right and left leg plates 2b; at the end of the legs 2d, short and small protrusion shafts 2e protruding inwardly from each other are respectively formed by press machining.

The protrusion shaft 2e facing each other formed on the right and left legs 2d are inserted from the outside into the pair of shaft holes 1g on the front end side of the case body 1 and the lid 2 is rotatably mounted on the front end of the case body 1.

Thus, the back plate 2a of the lid 2 is made flush with the back plate 1c of the case body 1, in the case of the first state in which the lid 2 is closed with the cover member 5 is most advanced against the case body 1, as shown in FIG. 2. In the case of the second state in which the cover member 5 is most retracted against the case body 1, as shown in FIG. 3, the refill removal opening 1b is made open by the hanging down of the lid 2 by its own weight.

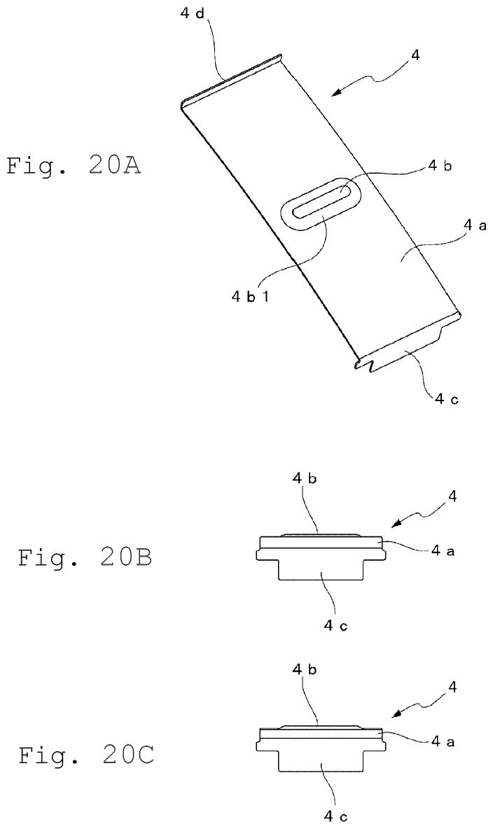

FIGS. 16A and 16B show the wall member 3. The wall member 3 is formed to have a U-shaped cross section perpendicular to the longitudinal direction by bending the pair of side plates 3b in the same direction, on the right and left edges of the longitudinal direction of the long thin top plate 3a.

In addition, at the front end of the wall member 3, the side plates 3b are extended and bent outwardly obliquely so as to be separated from each other to form a pair of protective plates 3c. At the back end of the wall member 3, the side plates 3b are extended and also bent outwardly at right angles to each other to form a pair of locking pieces 3d.

Furthermore, erecting pieces 3e are formed by bending in the opposite direction to the bending direction of the pair of side plates 3b at the front end of the top plate 3a.

The wall member 3 thus composed is mounted so as to cover the refill lead accommodating space la of the case body 1, with the top plate 3a facing upward. The refill lead accommodating space la is formed by being surrounded by the top plate 3a of the wall member 3 and both of the right and left side plates 3b.

At the time of mounting the wall member 3 to the case body 1, the pair of locking pieces 3d formed at the rear end of the wall member 3 is inserted into the gaps in the case body 1 formed between the rear end blocking plate 1e and the right and left leg plates 1d respectively, thereby preventing the wall member 3 from moving in the case body 1 in the longitudinal direction.

As described above, the protective plates 3c of the wall member 3 are located on the right and left sides of the refill lead removal opening 1b of the case body 1, as shown in FIG. 3, by mounting the wall member 3 in the case body 1, thereby controlling the tip end of the refill lead accommodated in the refill lead accommodating space 1a to be directed in the longitudinal direction of the refill lead case. This control prevents the problem of the tip end of the refill leads accommodated in the refill lead accommodating space 1a from being broken by getting stuck between the lid 2 and the tip end of the case body 1 when the lid 2 is closed by the sliding movement of the cover member 5 against the case body 1 as shown in FIG. 2.

Furthermore, the erecting piece 3e provided in the wall member 3 prevents the erroneous insertion of the refill lead by closing the gap between the top plate 3a of the wall member 3 and the front face plate 5a of the cover member 5, which will be described later.

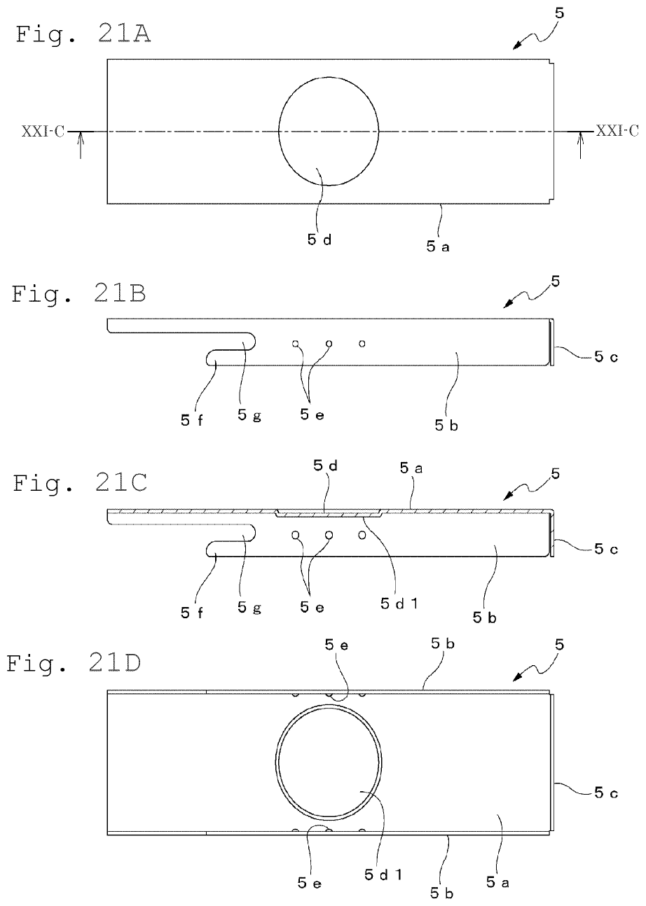

FIGS. 17A and 17B show a single-article configuration of the plate spring 4 composed of a rectangular plate member. The rectangular plate member is plastically deformed to form a curved plate such that the central portion thereof is convex toward the upper side; at the central portion of the curved plate 4a protrusions 4b (hereinafter referred to as a spring side protrusion) are formed to protrude in a long and narrow manner in the direction perpendicular to the longitudinal direction. The upper surface of the long and narrow spring side protrusion 4b is made nearly flat and an inclined surface 4b1 is formed so as to surround the spring side protrusion 4b between the curved plate 4a.

At the rear end of the plate spring 4, a rear end bent piece 4c is formed by bending the end of the curved plate 4a almost at right angles to the opposite side of the protruding direction of the spring side protrusion 4b. At the tip end of the plate spring 4, a front end erecting piece 4d is formed by bending the end of the curved plate 4a almost at right angles in the same direction as the protruding direction of the spring side protrusion 4b.

The plate spring 4 is mounted on the wall member 3 covering the refill lead accommodating space 1a of the case body 1 with the spring side protrusion 4b facing upward.

In this case, the plate spring 4 is fixed to the case body 1 while preventing movement in the longitudinal direction by inserting the rear end bent piece 4c into the gap formed between the rear end blocking plate le of the case body 1 and the top plate 3a of the wall member 3.

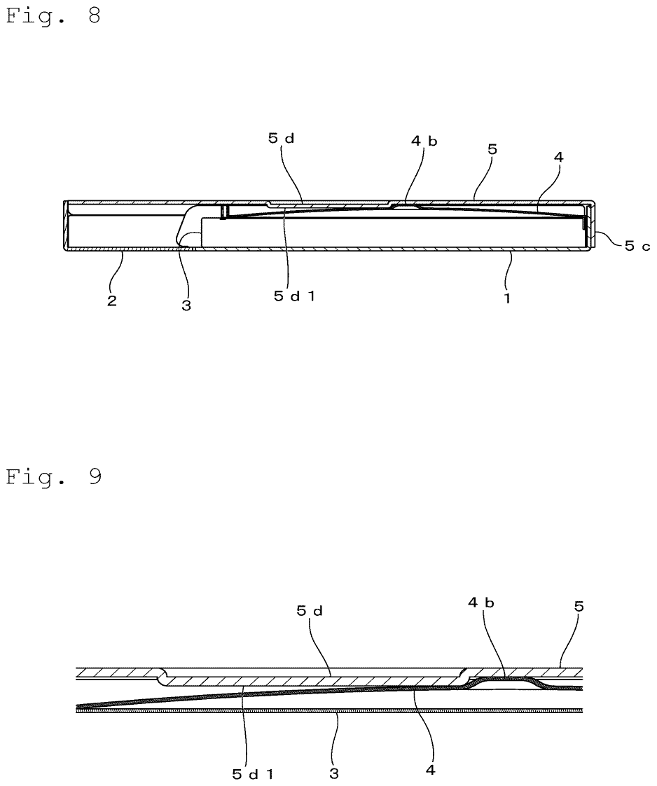

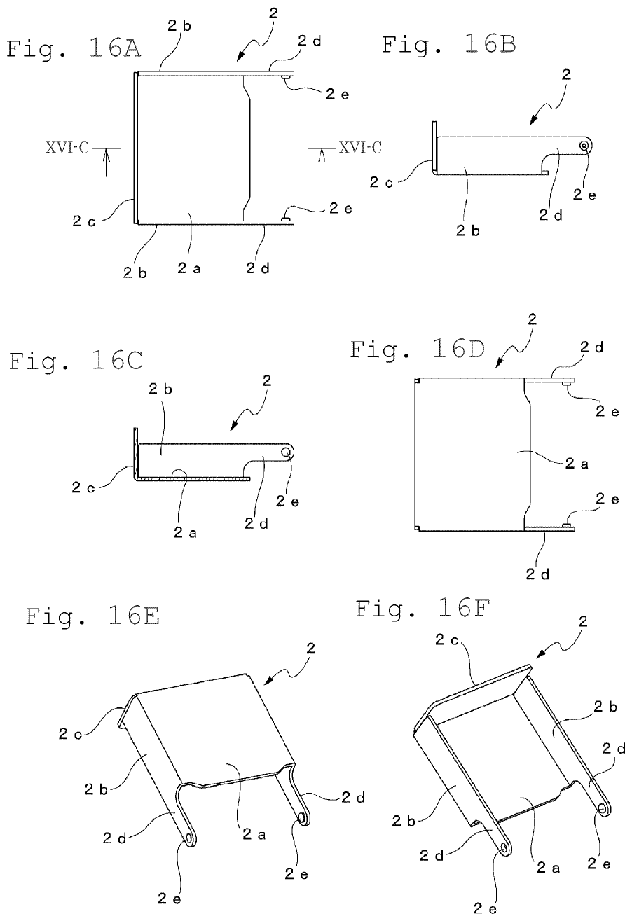

The front end erecting piece 4d of the plate spring 4 arranged on the case body 1 side is disposed just behind the erecting piece 3e formed in the wall member 3 in a parallel state (see FIG. 8 and FIG. 12).

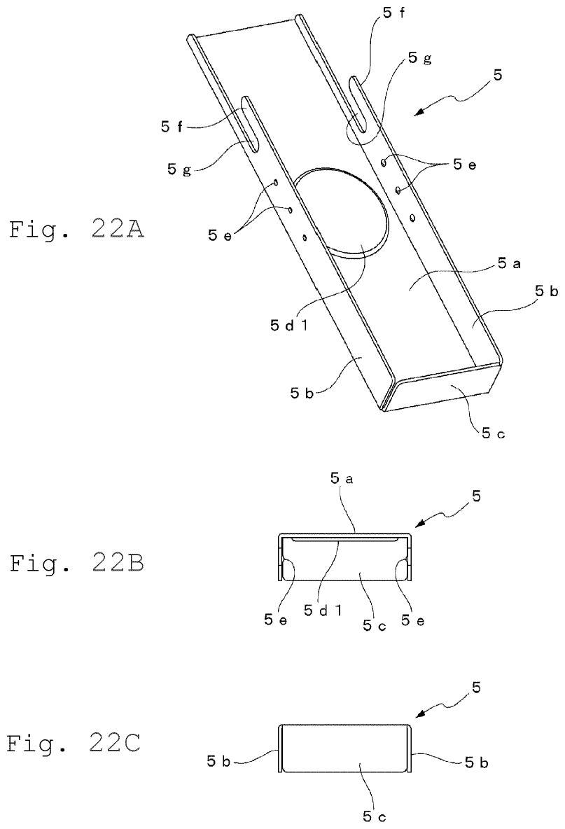

FIGS. 18A and 18B show a single-article configuration of the cover member 5. The cover member 5 is formed to have a cross-section in a U-shape perpendicular to the longitudinal direction of the cover member 5 by bending the pair of outer leg plates 5b in the same direction at the right and left edges of the longitudinal direction of the front face plate 5a formed in a rectangular shape. The rear end of the front face plate 5a forms the rear end outer blocking plate 5c by bending in the same direction as the outer leg plates 5b.

A circular recess 5d is formed on the upper central portion of the front face plate 5a by press machining. The recess 5b allows smooth sliding operation while preventing the cover member 5 from slipping against the thumb by placing the thumb pad when the cover member 5 is slid against the case body 1.

The circular recess 5d is formed as a circular bump on the back side of the front face plate 5a and serves as the click protrusion 5d1 which causes a click action by touching the spring side protrusion 4b on the plate spring 4 side during the sliding operation. The resulting click action will be described later.

Three small protrusion-like sliders 5e protruding inwardly from both outsides of each of the outer leg plates 5b are linearly arranged at the central portion of the longitudinal direction of the right and left pair of outer leg plates 5b, respectively. The cover member 5 is slidably supported against the case body 1 in the longitudinal direction by fitting the small protrusion-like sliders 5e from the outside into the linear recess 1f formed on the right and left leg plates 1d of the case body 1, respectively.

The bending dimension of the outer leg plate 5b is made small relative to the front face plate 5a at the front end side of the right and left pair of outer leg plates 5b, and a short guide arm 5f extending forward from the outer leg is formed at the outer leg 5b having the small bending dimension. Thus, a guide slot 5g is formed between the guide arm 5f and the outer leg 5b having the small bending dimension.

The guide arm 5f and the guide slot 5g realize the open-close operation of the lid 2 by the sliding operation of the cover member 5 against the case body 1; the open-close operation of the lid 2 will be described later.

As described above, the refill lead case which is provided with each member indicated reference signs of 1 to 5 is assembled by fitting the small protrusion-like slider be formed on the outer leg plate 5b of the cover member 5 from the outside into the linear recesses 1f formed on the right and left leg plates 1d of the case body 1.

In the above refill lead case, the spring side protrusion 4b formed on the central portion of the curved plate 4a of the plate spring 4 is in a state of contact with the back surface of the front face plate 5a of the cover member 5 with proper spring pressure.

Meanwhile, the clicking protrusion 5d1, formed on the cover member 5, is configured to be circular in shape and has a predetermined length corresponding to the diameter of the circular shape along the sliding direction, the longitudinal direction of the cover member 5.

By the sliding operation described above, the spring side protrusion 4b of the plate spring 4 climbs onto the clicking protrusion 5d1 formed on the cover member 5. Then, at the end of the clicking protrusion 5d1, the spring side protrusion 4b, after climbing over the clicking protrusion, falls onto the front face plate 5a side of the cover member 5; at this moment, a feeling of a clear clicking action can be obtained.

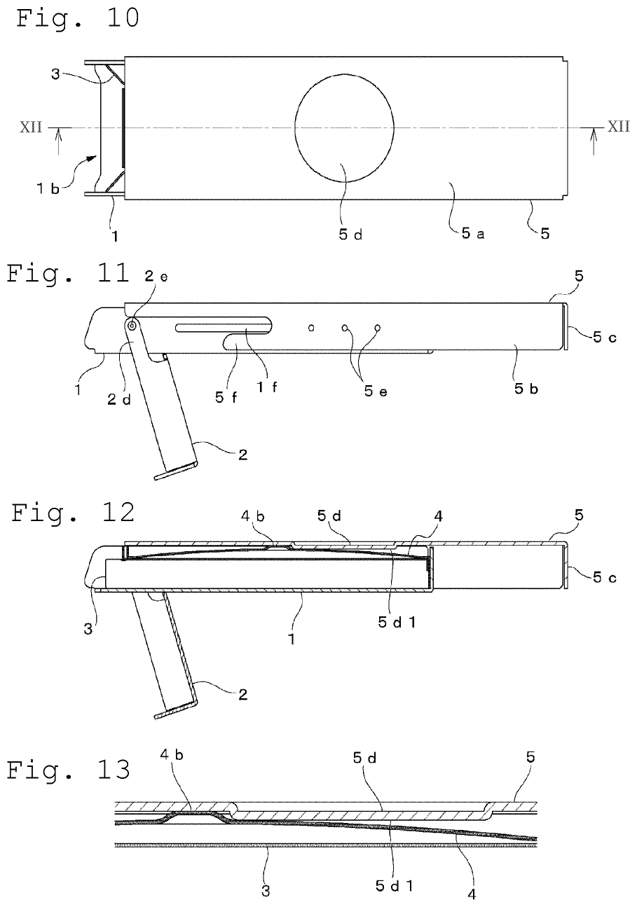

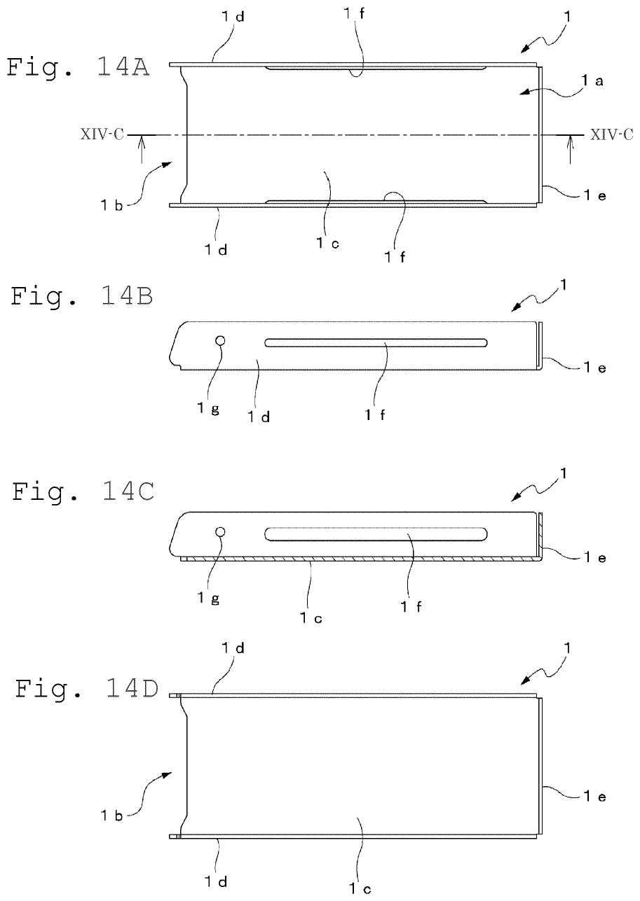

FIGS. 8 and 9 show the positional relationship between the clicking protrusion 5d1 of the cover member 5 side and the spring side protrusion 4b of the plate spring 4 side in the first state (see FIG. 2) in which the cover member 5 is most advanced against the case body 1 by the sliding operation described above.

In the first state, the small protrusion-like slide 5e located at the frontmost end side formed on the right and left outer leg plates 5b of the cover member 5 is located at the front end side of the linear recess 1f formed on the right and left leg plates 1d of the case body 1. As shown in FIG. 8, the rear end outer blocking plate 5c of the cover member 5 is in a state of contact with the rear end blocking plate le of the case body 1. Accordingly, the advancement of the cover member 5 toward the case body 1 is in a state of being blocked.

In the first state, as shown in FIG. 9, the spring side protrusion 4b of the plate spring 4 side is located in a state of having fallen on the back side of the front face plate 5a of the cover member 5 just behind the clicking protrusion 5d1 of the cover member 5.

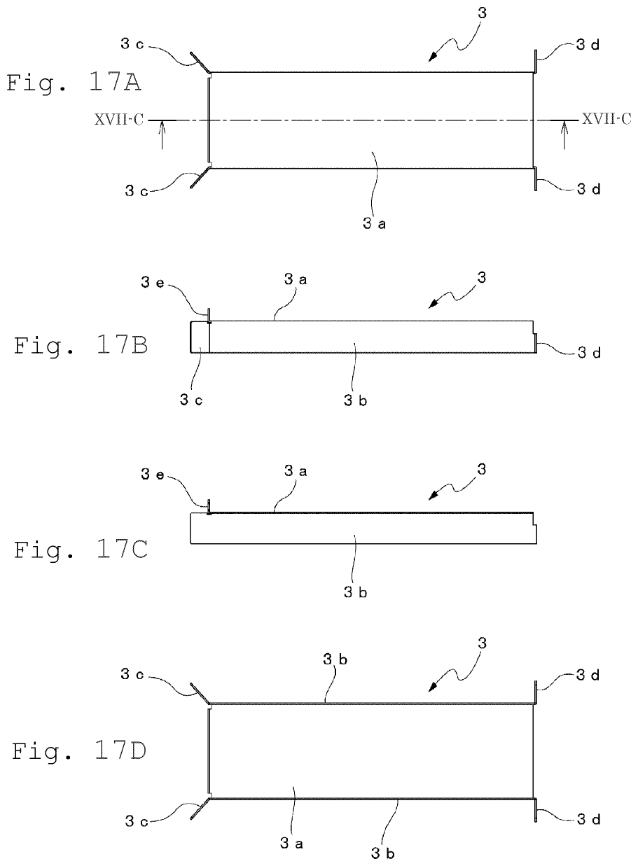

FIGS. 12 and 13 show the positional relationship between the clicking protrusion 5d1 of the cover member 5 side and the spring side protrusion 4b of the plate spring 4 side in the second state (see FIG. 3) in which the cover member 5 is most retracted against the case body 1 by the sliding operation described above.

In the second state, the small protrusion-like slider 5e located at the rearmost end side formed on the right and left outer leg plates 5b of the cover member 5 is in a state of being located at the rear end side of the linear recess 1f formed on the right and left leg plates 1d of the case body 1. Accordingly, the further retraction of the cover member 5 toward the case body 1 is in a state of being blocked.

In the second state, as shown in FIG. 13, the spring side protrusion 4b of the plate spring 4 side is located in a state of having fallen on the back side of the front face plate 5a of the cover member 5, just before the clicking protrusion 5d1 of the cover member 5.

Accordingly, with this refill lead case, a sliding operation accompanied by a distinct clicking sensation can be obtained at the transition from the first state to the second state or from the second state to the first state.

In addition, the clicking protrusion 5d1 described above may be formed on the inner surface of the front face plate 5a of the cover member 5. This clicking protrusion can be both wide and perpendicular to the longitudinal direction. Thus, it is possible to provide a refill lead case that has an operating feeling accompanied by a distinct clicking sensation during the relative sliding operation between the case body 1 and the cover member 5, and at the same time that is capable of maintaining a proper clicking function while preventing the clicking protrusion from wearing out over an extended period.

Meanwhile, the open-close operation of the lid 2, located at the front end of the refill lead case, is performed at the refill lead removal opening 1b by the sliding operation.

More specifically, in the first state shown in FIG. 2, the legs 2d of the lid 2 are accommodated in the slit 5g provided on the cover member 5 (see FIG. 18A), and the legs 2d are constrained to maintain the same orientation as the longitudinal direction of the cover member 5, thereby maintaining the state in which the lid 2 closes the refill lead removal opening.

In the second state shown in FIG. 3, the cover member 5 is retracted from the case body 1, and the legs 2d of the lid 2 are released from the constraint by the guide slot provided in the cover member 5. This allows the lid 2 to rotate by means of the protruding shaft 2e supported by the shaft hole 1g of the case body 1; the lid 2 hangs down by its own weight, and the refill lead removal opening 1b is opened.

When the case body 1 is returned from the second state shown in FIG. 3 to the first state shown in FIG. 2, the protruding shaft 2e rotatably supporting the lid 2 enters the guide slot 5g provided in the cover member 5 accompanied by the advancement of the cover member 5 against the case body and the legs 2d of the lid are fitted into the guide slot 5g. As a result, the legs 2d of the lid 2 are received in the guide slot 5g provided in the cover member 5, the legs 2d are rotated toward the cover member 5 and the legs 2d are constrained to maintain the same orientation as the longitudinal direction of the cover member 5. As a result, the lid 2 is brought into a state to close the refill lead removal opening 1d as shown in FIG. 2.

As described above, according to the refill case of this embodiment, the appropriate clicking action is performed by the sliding operation of the cover member 5 against the case body 1, and the lid 2 opens and closes the refill lead removal opening 1b in conjunction with the sliding operation thereof so that it is possible to provide a refill lead case that is easy for users to use.

In the embodiment described above, although a wall member 3 is provided in the refill lead case, the wall member 3 is not necessarily required.

In this embodiment, the wall member 3 functions to support the front end of the plate spring 4 in the top plate 3a. However, the wall member 3 can be omitted by configuring the refill lead removal opening 1b not to be blocked with the plate spring 4 by locking the front end of the plate spring with a portion of the case body 1.

### REFERENCE SIGNS LIST

1 case body
1a refill lead accommodating space
1b refill lead removal opening
1c back plate
1d leg plate
1e rear end blocking plate
1f linear recess
1g shaft hole
2 lid
2a back plate
2b leg plate
2c front end blocking plate
2d leg
2e protrusion shaft
3 wall member
3a top plate
3b side plate
3c protective plate
3d locking piece
3e erecting piece
4 plate spring
4a curved plate
4b spring side protrusion
4b1 inclined surface
4c rear end bent piece
4d front end erecting piece
5 cover member
5a front face plate
5b outer leg plate
5c rear end outer blocking plate
5d recess
5d1 clicking protrusion
5e slider
5f guide arm
5g guide slot

1. A refill lead case, comprising:
a case body having a refill lead accommodating space which is defined by an inner space formed in the shape of a long article by being surrounded by a back plate and right and left leg plates, the case body being provided with a lid that is openably attached to a refill lead removal opening formed at one end of the refill lead accommodating space in the longitudinal direction; and
a cover member having a front plate that covers the refill lead accommodating space with a predetermined distance from the back plate of the case body and is slidably movable against the case body along the longitudinal direction of the accommodating space, wherein
on the inner surface facing the case body of the front plate of the cover member, clicking protrusions are formed to cause a clicking action between the front plate and the case body by the sliding operation, and the lid covering the refill lead removal opening is opened accompanying the sliding operation of retracting the cover member toward the other end relative to the case body.

2. The refill lead case according to claim 1, wherein
a wall member is disposed in the case body to cover the refill lead accommodating space of the case body and a plate spring is also disposed by being fixed to the case body between the wall member and the cover member, and on the surface of the plate spring facing the cover member, a spring side protrusion is formed, by which a clicking operation is performed by climbing over the clicking protrusions formed on the cover member by the sliding operation.

3. The refill lead case according to claim 2, wherein
each of the case body, the lid, the cover member, the wall member, and the plate spring is made of a metallic material.

4. The refill lead case according to claim 2, wherein
the clicking protrusion formed on the cover member has a predetermined length along the direction of sliding against the case body, and the spring side protrusion is configured to climb over the clicking protrusions by sliding operation, in a first state where the cover member is most advanced against the case body and the lid is closed and in a second state where the cover member is most retracted backward and the cover member is open.
